(19) United States
(12) Patent Application Publication
(10) Pub. No.: US 2025/0115702 A1
(43) Pub. Date: Apr. 10, 2025

(54) MODIFIED DIENE RUBBERS

(71) Applicant: ARLANXEO DEUTSCHLAND GMBH, Dormagen (DE)

(72) Inventor: Benjamin GUTSCHANK, Dormagen (DE)

(73) Assignee: ARLANXEO DEUTSCHLAND GMBH, Dormagen (DE)

(21) Appl. No.: 18/836,579

(22) PCT Filed: Feb. 8, 2023
(86) PCT No.: PCT/EP2023/053033

§ 371 Date: Aug. 7, 2024

(30) Foreign Application Priority Data
Feb. 11, 2022 (EP) 22156373.7

(51) Int. Cl. C08F 279/02; C08F 236/06

(52) U.S. Cl. CPC C08F 279/02; C08F 236/06

(57) ABSTRACT

A method of making a polydiene polymer having at least 50% by weight based on the weight of the polymer of units derived from one or more conjugated diene, wherein the method comprises a polymerization with at least one aliphatic conjugated diene monomer having from 4 to 25 carbon atoms and, optionally, one or more comonomer, wherein the method further comprises using at least one functionalizing comonomer according to formula (1)

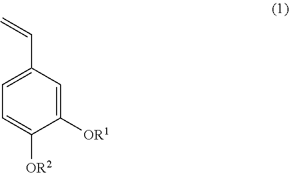

wherein the functionalising comonomer is either used at the beginning of the polymerization to produce an alpha-functionalized polymer or at the end of the polymerization to produce an omega-functionalized polymer or during the polymerization to produce a backbone-modified polymer, or a combination thereof, and wherein in formula (1),

R¹ and R² are selected independently selected from each other from alkyl residues having from 1 to 12 carbon atoms, which may, optionally, contain one or more ether or halogen atoms, and trialkyl silane residues of formula (2)

(R³)(R⁴)(R⁵)Si— (2)

wherein R³, R⁴ and R⁵ are selected independently from each other from alkyl residues having from 3 to 32 carbon atoms which may, optionally, contain one or more ether or halogen atoms and wherein at least one of R³, R⁴ and R⁵ is branched, and wherein at least one of R¹ and R² is a trialkyl silane residue of formula (2).

Also provided are compositions comprising a polymer obtained by the method, articles comprising a cured polymer and methods of making a cured article.

### BACKGROUND

Diene rubbers are widely used as raw material for producing tires. The rubbers can be functionalized to contain one or more polar groups, for example by treatment of the polymers with functionalization agents or by using functionalized comonomers in the polymerization reaction or both. Functionalized rubbers are known to improve the interactions between rubbers and fillers in tire compounds and thus the end properties of tires. Functionalized rubbers, however, are more difficult to process than their non-functionalized counterparts, which is believed to be caused by interactions of the functional groups. In US 2021/0230416 A1 functionalized rubbers are disclosed that were obtained by using a vinyl styrene comonomer containing two functional groups selected from the group consisting of carbon, hydrogen and silicon. As specific examples were reported methyl and ethyl groups which may be used as phenol-protecting groups, silicon-based functional groups (functional groups containing carbon, hydrogen, and silicon) such as trimethylsilyl and triethoxysilyl groups. Preferred among there were hydrocarbon-based functional groups, preferably alkyl groups. Polymers produced with the functionalized styrene were reported to have improved fuel efficiency values and improved wet grip. However, it was found that polymers functionalized with phenols containing low alkoxy silyl groups were difficult to polymerize and did not yield well-defined polymers.

### SUMMARY

Therefore, in one aspect there is provided a method of making a polydiene polymer having at least 51% by weight based on the weight of the polymer of units derived from one or more conjugated diene, wherein the method comprises a polymerization with at least one aliphatic conjugated diene monomer having from 4 to 25 carbon atoms and, optionally, one or more comonomer, wherein the method further comprises using at least one functionalizing comonomer according to formula (1)

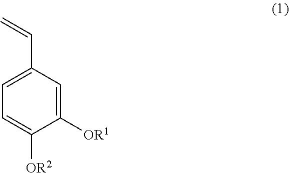

wherein the functionalising comonomer is either used at the beginning of the polymerization to produce an alpha-functionalized polymer or at the end of the polymerization to produce an omega-functionalized polymer or during the polymerization to produce a backbone-modified polymer, or a combination thereof, and wherein in formula (1),

R¹ and R² are selected independently selected from each other from alkyl residues having from 1 to 12 carbon atoms, which, optionally, may contain one or more halogen atoms or catenary ether oxygen atoms, and trialkyl silane residues of formula (2)

(R³)(R⁴)(R⁵)Si— (2)

wherein R³, R⁴ and R⁵ are selected independently from each other from alkyl residues having from 3 to 32 carbon atoms which, optionally, may contain one or more halogen atoms or catenary ether oxygen atoms, and wherein at least one of R³, R⁴ and R⁵ is branched, and wherein at least one of R¹ and R² is a trialkyl silane residue of formula (2).

In another aspect there is provided a composition comprising a polymer obtained by the method.

In a further aspect there is provided an article comprising a cured composition obtained by subjecting the composition to a curing reaction.

In yet a further aspect there is provided a method of making a cured article comprising subjecting the composition to a curing reaction.

### DESCRIPTION OF THE FIGURE

FIG. 1 shows the GPC traces for determining the polydispersity indices of the polydiene polymers obtained in the example section. The GPC trace of the comparative polymer obtained with TES-4VG (a functionalizing comonomer with linear functional groups) is very broad and thus shows an ill-characterized polymer having a lot of different molecular weight fractions. The polymers obtained with a functionalizing comonomer according to the present disclosure were well defined and had GPC traces similar to the traces of the non-functionalized or differently functionalized reference polymers.

### DETAILED DESCRIPTION

The present disclosure will be further illustrated in the following detailed description.

In the following description certain standards (ASTM, DIN, ISO etc) may be referred to. If not indicated otherwise, the standards are used in the version that was in force on Mar. 1, 2020. If no version was in force at that date because, for example, the standard has expired, then the version is referred to that was in force at a date that is closest to Mar. 1, 2020.

All documents recited in this description are incorporated by reference, unless indicated otherwise.

In the following description the amounts of ingredients of a composition or a polymer may be indicated interchangeably by “weight percent”, “wt. %” or “% by weight”. The terms “weight percent”, “wt. %” or “% by weight” are based on the total weight of the composition or polymer, respectively, which is 100% unless indicated otherwise.

The term “phr” means “parts per hundred parts of rubber”, i.e. the weight percentage of an ingredient of a composition containing one or more rubber is based on the total amount of rubber which is set to 100% by weight. Therefore, total weight of the composition is usually greater than the amount of rubber and can be greater than 100% by weight.

Ranges identified in this disclosure are meant to include and disclose all values between the endpoints of the range and its end points, unless stated otherwise.

The terms “comprising”, “containing” and “having” are used in an open, non-limiting meaning. For example, the phrase “a composition comprising ingredients A and B” is meant to include ingredients A and B but the composition may also have other ingredients. Contrary to the use of “comprising”, “containing” or “having” the word “consisting of” is used in a narrow, limiting meaning. The phrase “a composition consisting of ingredients A and B” is meant to describe a composition of ingredients A and B and no other ingredients.

### Functionalized Comonomers

The functionalized comonomers according to the present disclosure correspond to the general formula (1)

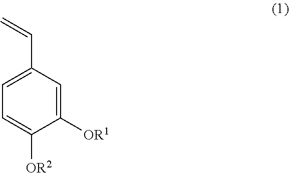

wherein the functionalized comonomer is either used at the beginning of the polymerization to produce an alpha-functionalized polymer or at the end of the polymerization to produce an omega-functionalized polymer or during the polymerization to produce a backbone-modified polymer, or a combination thereof, and wherein in formula (1),

R¹ and R² are selected independently selected from each other from alkyl residues having from 1 to 12 carbon atoms which, optionally, contain one or more halogen atoms or catenary ether oxygen atoms, and trialkyl silane residues of formula (2)

(R³)(R⁴)(R⁵)Si— (2),

wherein R³, R⁴ and R⁵ are selected independently from each other from alkyl residues having from 3 to 32 carbon atoms, which may, optionally, contain one or more halogen atoms or catenary ether oxygen atoms, and wherein at least one of R³, R⁴ and R⁵ is branched, and wherein at least one of R¹ and R² is a trialkyl silane residue of formula (2). Preferably, the branched alkyl residue corresponds to the general formula (3):

(R′)(R″)(R″′)C—(CH₂)ₙ— (3),

wherein n represents 0, 1, or 2, and R′, R″ and R″′ are selected independently from each other from H, or an alkyl of 1 to 10 carbon atoms which, optionally, may contain one or more halogen atoms or catenary ether oxygen atoms, with the proviso that not more than one of R′, R″ and R″′ is H. Preferably, R′ R″ and R′ are selected independently from each from an alkyl of 1 to 5 carbon atoms. Preferably n is 0.

In one embodiment of the present disclosure the trialkyl silane residue is selected from (R′)(R″)(R″′)Si—, wherein R′ and R″ are both selected from methyl, ethyl, propyl, butyl and R″′ is selected from tert.-butyl, sec.-butyl, neopentyl, isopropyl. In another embodiment the present disclosure R′, preferably R′ and R″, are tert.-butyl.

In another embodiment of the present disclosure the trialkyl silane residue is selected from (R′)(R″)(R″′)Si—, wherein R′ is selected from methyl, ethyl, propyl, butyl and both R″ and R″′ are selected independently from each other from tert.-butyl, sec.-butyl, neopentyl, isopropyl. In another embodiment the present disclosure R′, preferably R′ and R″, are tert.-butyl.

In one embodiment of the present disclosure one of R¹ or R², preferably R¹, is a linear or branched alkyl group with 1 to 6 carbon atoms, preferably a methyl or an ethyl group.

Specific examples include but are not limited to tert.-butyldimethylsilyloxy-4-vinyl-2-methoxybenzene; 2-tert.-butyldimethylsilyloxy-4-vinyl-1-methoxybenzene; tert.-butyldimethylsilyloxy-4-vinyl-2-ethoxybenzene; 2-tert.-butyldimethylsilyloxy-4-vinyl-1-ethoxybenzene; 2-tert.-butyldimethylsilyloxy-4-vinyl-1-propoxybenzene, tert.-butyldimethylsilyloxy-4-vinyl-2-propoxybenzene and combinations thereof.

The functionalized comonomers are used in a reaction with conjugated diene monomers to produce polydiene polymers. The functionalized comonomers can be used at the beginning of the polymerization reaction to produce an alpha-functionalized polydiene polymer or at the end of the polymerization to produce an omega-functionalized polydiene polymer or during the polymerization to produce a backbone-modified polydiene polymer, or a combination thereof. The functionalized monomer introduces the functional groups —OR¹ and —OR² into the polymer. Since at least one of the groups —OR¹ and —OR² are siloxane groups they can be converted into —OH or —OM groups, wherein M is a cation, for example by a treatment comprising a reacting at least one of these groups with an acidic reagent. The acidic reagent includes a Bronstedt acid and a Lewis acid. A polydiene polymer that has been treated to convert the —OR¹ or —OR² groups or both is referred to herein as “converted polymer”. In one embodiment the method according to the present disclosure further comprises exchanging at least one of the residues R¹ and R² with hydrogen or a cation through treatment with at least one acidic agent.

In one embodiment of the present disclosure the functionalized monomer is reacted with itself to produce a second functionalized comonomer comprising repeating units derived from the functionalising comonomer according to formula (1). This second functionalized monomer, also referred to herein as “polyfunctionalized monomer”, can be used in a polymerization reaction with one or more conjugated dienes and other copolymerizable comonomers to produce a polydiene polymer according to the present disclosure. Such second functionalized monomers may be produced in essentially the same way as described below for making the polymers, except that only low amounts of repeat units may be created, for example, from 2 to 1,000 or 10 to 100 repeat units. The polyfunctionalized comonomers may be added before, during, or at the end of the polymerization reaction with the conjugated monomers. Preferably, the at least one functionalized monomer is reacted first to produce the second functionalized comonomer before the conjugated dienes are reacted in the polymerization reaction because this may increase the conversion rate of the dienes and thus leads to a faster polymerization.

The amounts of functional comonomers to be used include, for example but not limited to, amounts of from 0.001% to 10% by weight based on the total weight of the polymer, or from 0.1% to 1% by weight. Therefore, the polydiene polymer according to the present disclosure may comprise from 0.001 to 10% by weight of units derived from one or more functional comonomer according to formula (1) or its converted form with at least one of —OR¹ and —OR² being replaced by —OH or —OM, with M representing an organic or inorganic cation.

### Polydiene Polymers

The polydiene polymers according to the present disclosure preferably contain at least 51% by weight based on the total weight of the polymer of units derived from one or more conjugated diene monomer. The conjugated diene monomer may have from 4 to 25 carbon atoms.

The polymers may be homopolymers or copolymers and comprise units derived from at least one conjugated diene monomer. Suitable diene monomers include but are not limited to 1,3-butadiene, isoprene, 1,3-pentadiene, 2,3-dimethylbutadiene, 1-phenyl-1,3-butadiene, 1,3-hexadiene, myrcene, ocimene, farnesene and combinations thereof. Preferably the polymer comprises units derived from 1,3-butadiene or consists of units derived from 1,3-butadiene.

In one embodiment of the present disclosure the polymer is a copolymer obtained by a method comprising a polymerization reaction comprising at least two conjugated dienes. In another embodiment of the present disclosure the polymer is a copolymer obtained by a method comprising polymerizing at least one conjugated diene monomer and at least one vinyl aromatic comonomer. Examples of suitable vinyl aromatic comonomers include, but are not limited to, styrene, ortho-methyl styrene, meta-methyl styrene, para-methyl styrene, para-tertbutyl styrene, vinyl naphthalene, divinyl benzene, trivinyl benzene, divinyl naphthalene and combinations thereof. Styrene is particularly preferred.

In one embodiment of the present disclosure the polymers are butadiene polymers and include homopolymers and copolymers of 1,3-butadiene. Preferably, the polymers according to the present disclosure contain at least 50% by weight, preferably at least 60% by weight, based on the weight of the polymer, of units derived from 1,3-butadiene. In one embodiment of the present disclosure the diene polymers contain at least 60% by weight, or at least 75% by weight units derived from 1,3-butadiene.

In one embodiment of the present disclosure the diene polymers contain from 0 to 49% by weight, or from 0% to 40% by weight, based on the total weight of the polymer, of units derived from one or more comonomers.

In one embodiment of the present disclosure the diene polymers contain at least 60% by weight, or at least 70% by weight units derived from 1,3-butadiene and from 0 to 40% by weight, or from 0 to 30% by weight of units derived from one or more comonomers.

In one embodiment the diene polymers of the present disclosure contain from 0 to 20% by weight of units derived from one or more conjugated dienes other than 1,3 butadiene.

In one embodiment the diene polymers according to the present disclosure contain at least 50% by weight, preferably at least 60% by weight, based on the weight of the polymer, of units derived from 1,3-butadiene and up to 49% by weight of units derived from one or more vinyl aromatic comonomer, preferably from 5% to 40% by weight, or from 10% to 35% by weight, of units derived from one or more vinyl aromatic comonomer.

In one embodiment the polymer according to the present disclosure comprises at least 75% or at least 95% by weight of units derived from one or more than conjugated diene monomers. In one embodiment the polymer according to the present disclosure comprises from 55% to 92% by weight of units derived from one or more conjugated diene monomers and from 5.8% to 45% by weight of units derived from vinyl aromatic comonomers.

Suitable copolymerizable comonomers further include one or more alpha-olefins, for example, ethene, propene, 1-butene, 1-pentene, 1-hexene, 4-methyl-1-pentene, 1-octene and combinations thereof.

In one embodiment, the diene polymers according to the present disclosure contain from 0 to 20% by weight of units derived from ethene, propene, 1-butene, 1-pentene, 1-hexene, 4-methyl-1-pentene, 1-octene and combinations thereof.

Suitable comonomers also include, but are not limited to, one or more other co-polymerizable comonomers that introduce functional groups-other than the functional comonomers above-including cross-linking sites, branching sites, branches or functionalized groups. In one embodiment of the present disclosure the diene polymers contain from 0% to 10% by weight or from 0% to 5% by weight of units derived from one or more of such other comonomers.

Combinations of one or more of comonomers of the same chemical type as described above as well as combinations of one or more comonomers from different chemical types may be used.

The diene polymers according to the present disclosure may have a Mooney viscosity ML 1+4 at 100° C. of from 10 to 200 Mooney units, for example from 30 to 150 or from 35 to 85 Mooney units.

The diene polymers according to the present disclosure may have a number-averaged molecular weight (Mn) of from 10,000 g/mole to 2,000,000 g/mole, or from 100,000 to 1,000,000 g/mole, for example from 100,000 to 400,000 g/mole or from 200,000 to 300,000 g/mole. In one embodiment of the present disclosure, the polymers have an Mn of from 150 kg/mole to 320 kg/mole.

The diene polymers according to the present disclosure may have a dispersity (also referred to herein as molecular weight distribution or MWD) from 1.03 to 25, for example from 1.03 to 5. In one embodiment of the present disclosure the polymers have an MWD of from 1.03 to 3.5 or from 1.03 to 2.40. The MWD is the ratio of the weight-averaged molecular weight (Mw) to the number averaged molecular weight Mn, i.e., MWD equals Mw/Mn.

The diene polymers according to the present disclosure typically are rubbers and typically have a glass transition temperature of less than 20° C. They may have a glass transition temperature (Tg), for example, of from −120° C. to less than 20° C. In a preferred embodiment of the present disclosure the polymers have a Tg of from 0° C. to −110° C. or from −10° C. to −80° C. In one embodiment of the present disclosure the butadiene polymer has a glass transition temperature of from about −90° to −110° C.

In one embodiment of the present disclosure the diene polymers have a number-averaged molecular weight of from 100,000 to 1,000,000 and a Mooney viscosity ML 1+4 at 100° C. of from 30 to 150 units and a glass transition temperature of from −110° C. to 0° C.

In one embodiment the diene polymers according to the present disclosure have a Mooney viscosity ML 1+4 at 100° C. of from 30 to 150 units, a number-averaged molecular weight of from 100,000 to 400,000 g/mole, a glass transition temperature of from −110° C. to 0° C. and a molecular weight distribution (MWD) from 1.03 to 2.40.

The polydiene polymers according to the present disclosure may be additionally functionalized and may contain one or more functional group introduced by one or more functionalization agents. Such groups, preferably end groups, typically containing, in addition to C and H atoms, at least one heteroatom selected from Si, S, N, O and a combination thereof, in particular a combination of Si and O atoms, Si and S atoms or Si, O and N atoms. Such additionally functionalized polymers are obtainable, for example, by a reaction comprising reacting reactive polymer chain ends with at least one functionalization reagent containing, in addition to C and H atoms, at least one heteroatom selected from Si, S, N, O and combinations thereof. If necessary, the reaction product of the functionalization reaction may subsequently be treated to generate at least one —OH, —SH or —COOH group or a combination thereof or an anionic form thereof selected from —O, —S, —COO groups and combinations thereof. Such treatment may include carrying out a hydrolysis reaction, for example by adding an alcohol or an acid, or includes a treatment with at least one other functionalization reagent that reacts with the first functionalization reagent to produce at least one —OH, —SH, or —COOH group or a combination thereof or an anionic form thereof selected from —O, —S, —COO.

Alternatively, or in addition, coupling agents may be used to link polymer chains as is known in the art. Typical coupling agents known in the art include but are not limited to tetra alkoxy silanes and tetrachlorosilane.

### Methods of Making Polymers

The homo- or copolymers of the present disclosure can be prepared by methods known in the art. The polymerization may be carried out to produce a statistical polymer, also called random copolymer, a block-copolymer, a gradient copolymer or combinations of them and include linear and branched architectures as known by the person skilled in the art.

The polymers can be obtained by a process comprising an anionic polymerization or a catalytic polymerization using one or more coordination catalysts. Coordination catalysts in this context include Ziegler-Natta catalysts or monometallic catalyst systems. Preferred coordination catalysts are those based on Ni, Co, Ti, Zr, Nd, V, Gd, Cr, Mo, W or Fe. Preferably the polymerization reaction comprises an anionic solution polymerization. Initiators for anionic solution polymerization include organometals, preferably based on alkali or alkaline earth metals. Examples include but are not limited to methyllithium, ethyllithium, isopropyllithium, n-butyllithium, sec-butyllithium, pentyllithium, n-hexyllithium, cyclohexyllithium, octyllithium, decyl-lithium, 2-(6-lithio-n-hexoxy) tetrahydropyran, 3-(tert-butyldimethylsiloxy)-1-propyllithium, phenyllithium, 4-butylphenyllithium, 1-naphthyllithium, p-toluyllithium and allyllithium compounds, derived from tertiary N-allylamines such as [1-(dimethylamino)-2-propenyl]lithium, [1-[bis(phenylmethyl)amino]-2-propenyl]lithium, [1-(diphenylamino)-2-propenyl]lithium, [1-(1-pyrrolidinyl)-2-propenyl] lithium, lithium amides of secondary amines such as lithium pyrrolidide, lithium piperidide, lithium hexamethylene imide, lithium 1-methyl imidazolidide, lithium 1-methyl piperazide, lithium morpholide, lithium dicyclohexylamide, lithium dibenzyl amide, lithium diphenyl amide. The allyllithium compounds and the lithium amides can also be prepared in situ by reacting an organolithium compound with the respective tertiary N-allylamines or with the respective secondary amines. Di- and polyfunctional organolithium compounds can also be used, for example 1,4-dilithiobutane, dilithium piperazide. Preferably n-butyllithium, sec-butyllithium or a combination thereof are used. The initiator creates anionic, reactive monomers and the polymerization propagates by the reaction of the reactive carbanionic monomers with other monomers which creates reactive carbanionic polymer chain ends. In case of a polymerization using one or more coordination catalysts, the reactive chain ends are produced by the catalyst. When the functionalized monomer or the polyfunctionalized monomer or both are present at the start of the polymerization reaction, preferably before conjugated dienes or added, the polydiene polymer will be modified at the beginning of the polymer chains, i.e., in alpha-position.

Randomizers and control agents as known in the art can be used in the polymerization for controlling the structure of the polymer, in particular for avoiding aggregations or for increasing random structures. Such agents include, for example, diethyl ether, di-n-propylether, diisopropyl ether, di-n-butylether, ethylene glycol dimethyl ether, ethylene glycol diethyl ether, ethylene glycol di-n-butyl ether, ethylene glycol di-tert-butyl ether, diethylene glycol dimethyl ether, diethylene glycol diethyl ether, diethylene glycol di-n-butyl ether, diethylene glycol di-tert-butyl ether, 2-(2-ethoxyethoxy)-2-methyl-propane, triethylene glycol dimethyl ether, tetrahydrofuran, ethyltetrahydrofurfuryl ether, hexyltetrahydrofurfuryl ether, 2,2-bis(2-tetrahydrofuryl)propane, dioxane, trimethylamine, triethylamine, N,N, N′,N′-tetramethyl-ethylenediamine, N-methylmorpholine, N-ethylmorpholine, 1,2-dipiperi-dinoethane, 1,2-dipyrrolidinoethane, 1,2-dimorpholinoethane, potassium and sodium salts of alcohols, phenols, carboxylic acids, sulphonic acids and combinations thereof. In one embodiment of the present disclosure the polymer is a random polymer and, preferably, at least one randomizer is used in the polymerization reaction.

In one embodiment of the present disclosure the polymer is a random polymer. In one embodiment the polymer is a block-copolymer. For the generation of block copolymers, the polymerization is preferably started with one monomer and subsequently, depending on the size of the blocks to be performed the other (co)monomer(s) are added. The sequence of monomer additions can be adapted depending on which blocks of different monomers are desired to be created. In one embodiment of the present disclosure such a block is created at the beginning or at the end of the polymerization or both.

In one embodiment the polymerization is carried out in the presence of at least one solvent and preferably in solution. Preferred solvents for solution polymerizations include inert aprotic solvents, for example aliphatic hydrocarbons. Specific examples include, but are not limited to, butanes, pentanes, hexanes, heptanes, octanes, decanes and cyclopentane, methylcyclopentane, cyclohexane, methylcyclohexane, ethylcyclohexane, 1,4-dimethylcyclohexane and combinations thereof and including isomers thereof. Further examples include alkenes such as 1-butene or aromatic hydrocarbons such as benzene, toluene, ethylbenzene, xylene, diethylbenzene or propylbenzene and combinations thereof. These solvents can be used individually or as mixtures. Preferred solvents include cyclohexane, methylcyclopentane and n-hexane. The solvents may also be mixed with polar solvents if appropriate.

The polymerization can be carried out by first introducing the (co)monomers and solvent and then starting the polymerization by adding initiator or catalyst. The polymerization may also be carried out in a feed process where the polymerization reactor is filled by adding monomers and solvents. The initiator or catalyst are introduced or added with the monomers and solvent. Variations may be used, such as introducing the solvent in the reactor, adding initiator or catalyst followed by adding the monomers. The polymerization can be carried out in a continuous mode or batchwise. Further monomer and solvent may be added during or at the end of the polymerization. When the functionalizing comonomers are added during the polymerization or are present during the polymerization the functionalizing comonomers are built into the polymer backbone, leading to a polydiene polymer that is backbone-modified.

The polymerization can be carried out at normal pressure or at elevated pressure (for example, from 1 to 10 bar) or at reduced pressure. Typical reaction temperatures include room temperature but depending on the nature and amounts of comonomers the reaction temperature may be above or below room temperature. Typical ranges include, for example from −12° C. to 140° C. in a continuous adiabatic process, or from 50 to 120° C. in a batch process.

The polymerization reaction leads to reactive polymer chain ends, preferably anionic chain ends. To produce functional groups at the polymer chain ends (omega-position) a functionalizing comonomer according to the invention or functionalizing agents may be added to the polymerization medium towards the end of the reaction. Therefore, the method according to the present disclosure may further comprises the step reacting the polymer with at least one functionalization reagent for introducing at least one functional group to the polymer. Typically, such functionalization reagents are aliphatic compounds containing in addition to carbon and hydrogen atoms, heteroatoms selected from Si, O, S and N, preferably combinations of heteroatoms selected from Si and O, combinations of selected from Si, O and S, and combination of Si, O and N, or combinations of N and O. Typically, they lead, either directly or upon hydrolysis or reaction with another functional agent or both, to the polymer having at least one polar group selected from —OH, —COOH, —SH or salts thereof and combinations thereof. Preferably, the functionalization agent has a molecular weight of less than 5,000 g/mole or even less than 2,000 g/mole.

Functionalization reagents as known in the art may be used. Examples of functionalization agents include but are not limited to linear or branched alkoxysilanes and those described in US2013/0281605A1, US2013/0338300A1, US2013/0280458A1, US2016/0075809A1, US2016/0083495A1, WO2021/009154A1, U.S. Pat. No. 4,894,409 and WO2021/009156. Preferred functionalization agents include linear or branched alkoxysilanes, linear or branched silanes and the reagents selected from the group consisting of:

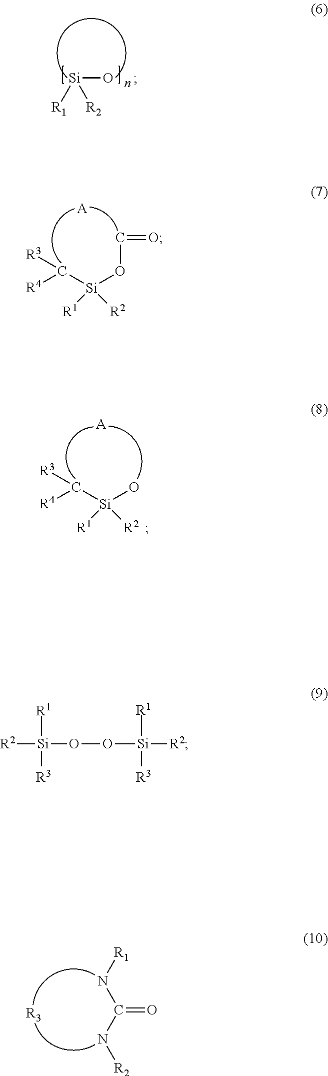

and combinations thereof.

In one embodiment of the present disclosure the functionalization reagent is a linear or branched silane or siloxane. In another embodiment of the present disclosure the functionalization reagent is a cyclic reagent. In one embodiment of the present disclosure the functionalization reagent is cyclic and has a 4- to 7-membered aliphatic cyclic ring, more preferably 5- or 6-membered aliphatic cyclic ring wherein the ring either has at least 2, preferably at least 3 carbon atoms and at least one heteroatom selected from N, O, S, Si or a combination thereof. In another embodiment of the present disclosure the functionalization reagent is cyclic and has a 3- to 20-membered cyclic structure wherein the ring has at least two, preferably at least three —Si(R1R2)—O— units, wherein R1 and R2 are, independently from each other, selected from H, a C₁-C₁₀ saturated hydrocarbon residue that, optionally, may contain one or more heteroatoms selected from O, N, S, Si or a combination thereof. Preferably, R1 and R2 are selected from methyl, ethyl, propyl and butyl.

Functionalization reagents according to formula (6):

Reagents according to formula (6) include cyclosiloxane-based functionalization reagents. In formula (6) R₁ and R₂ are the same or different and correspond to H, C₁-C₁₀ saturated or unsaturated hydrocarbon residue, preferably methyl, ethyl, propyl, butyl and vinyl or allyl, and wherein the C₁-C₁₀ saturated or unsaturated hydrocarbon residue, optionally, contains one or more heteroatoms selected from O, N, S, Si or a combination thereof, and n is an integer selected from 3 to 10, preferably 4 to 6. Specific examples of reagents according to formula (6) include not but are limited to hexamethylcyclotrisiloxane, octamethylcyclotetrasiloxane, decamethylcyclopentasiloxane and dodecamethylcyclohexasiloxane, Reagents according to formula (6) can lead directly or indirectly (for example via a subsequent hydrolysis) to silanol(—Si(R₁)(R₂)—OH) or silanolate (—Si(R₁)(R₂)—O) groups) as described, for example in US2016/0075809A1.

Functionalization reagents according to formula (7):

Reagents according to formula (7) include silalactone-based functionalization reagents. In formula (7) R¹ and R² are the same or different and are each selected from H or a residue having from 1 to 20 carbon atoms, preferably selected from alkyls, alkoxys, cycloalkyls, cycloalkoxys, aryls, aryloxys, alkaryls, alkaryloxy, aralkyls, or aralkoxys;

R³, R⁴are the same or different and are each selected from H or a residue having from 1 to 20 carbon atoms, preferably from alkyl, cycloalkyl, aryl, alkaryl or aralkyl,

A is a divalent organic radical, preferably having from 1 to 26 carbon atoms, and which may, in addition to hydrogen atoms, comprise heteroatoms selected from O, N, S and Si.

Preferably R¹, R² are the same or different and are selected from H, a (C₁-C₂₄)-alkyl, a (C₁-C₂₄)-alkoxy, a (C₃-C₂₄)-cycloalkyl, a (C₃-C₂₄)-cycloalkoxy, a (C₆-C₂₄)-aryl, a (C₆-C₂₄)-aryloxy, a (C₆-C₂₄)-alkaryl, a (C₆-C₂₄)-alkaryloxy, a (C₆-C₂₄)-aralkyl or a (C₆-C₂₄)-aralkoxy radical which, optionally, may contain one or more heteroatoms selected from O, N, S or Si.

Preferably R³, R⁴ are the same or different and are each selected from H, a (C₁-C₂₄)-alkyl, a (C₃-C₂₄)-cycloalkyl, a (C₆-C₂₄)-aryl, a (C₆-C₂₄)-alkaryl or a (C₆-C₂₄)-aralkyl radical, optionally containing one or more heteroatoms, selected from O, N, S or Si.

In one embodiment of the present disclosure A is represented by:

—Xn—(CY1H)m—(CY2Y3)o—(CY1H)p—

where

n is 1 or 0, m is 1, 2, 3 or 4, o is 0, 1 or 2, p is 0, 1 or 2, preferably the sum of n, m, o and p is 2 or 3;

X is O, S, NR, where R is H or C₁-C₃ alkyl or X is N(Si(alkyl)₃), wherein each “alkyl” independently from each other represents a C1 to C6 alkyl, -oxyalkyl or alkoxy;

Y1 is H or C1-C3 alkyl, Y2 is H or C1-C3 alkyl, Y3 is H or C1-C3 alkyl, preferably at least one of Y2 and Y3 is H.

Specific, non-limiting-examples of A include:

—CH₂—; —CH₂CH₂—; —CH₂CH₂CH₂—; —C(CH₃)—CH₂—; —CH₂—C(CH₃)—CH—; —CH(CH₃)—C(CH₃)H—;
—CH(CH₃)—CH₂—C(CH₃)H—; —CH₂—C(CH₃)H—C(CH₃)H—; —CH(CH₃)—C(CH₃)H—CH₂—; —O—CH₂—;
—O—CH₂CH₂—; —O—CH₂CH₂—CH₂—; —O—C(CH₃)H—; —O—CH₂CH₂—; —O—C(CH₃)H—CH₂—;
—O—CH₂—C(CH₃)H—; —O—CH₂—C(CH₃)H—CH₂—; —O—CH₂CH₂—C(CH₃)H—; —O—C(CH₃)H—CH₂—CH₂—;
—S—CH₂—; —S—CH₂CH₂—; —S—CH₂CH₂—CH₂—; —S—C(CH₃)H—; —S—CH₂CH₂—; —S—C(CH₃)H—CH₂—;
—S—CH₂—C(CH₃)H—; —S—CH₂—C(CH₃)H—CH₂—; —S—CH₂CH₂—C(CH₃)H—; —S—C(CH₃)H—CH₂—CH₂—;
—NH—CH₂—; —NH—CH₂CH₂—; —NH—CH₂CH₂—CH₂—; —NH—C(CH₃)H—CH₂—; —NH—CH₂—C(CH₃)H—;
—NH—CH₂—C(CH₃)H—CH₂—; —NH—CH₂CH₂—C(CH₃)H—; —NH—C(CH₃)H—CH₂—CH₂—;
—N(CH₃)—CH₂—; —N(CH₃)—CH₂—; —N(CH₃)—CH₂CH₂—; —N(CH₃)—CH₂CH₂—CH₂—;
—N(CH₃)—C(CH₃)H—CH₂—; —N(CH₃)—CH₂—C(CH₃)H—; —N(CH₃)—CH₂—C(CH₃)H—CH₂—;
—N(CH₃)—CH₂CH₂—C(CH₃)H—; —N(CH₃)—C(CH₃)H—CH₂—CH₂—;
N(Si(alkyl)₃)—CH₂—; —N(Si(alkyl)₃)—CH₂CH₂—; N(Si(alkyl)₃)—CH₂CH₂CH₂—;
—N(Si(alkyl)₃)—C(CH₃)H—; —N(Si(alkyl)₃)—CH₂CH₂—; —N(Si(alkyl)₃)—C(CH₃)H—CH₂—;
—N (Si(alkyl)₃)—CH₂—C(CH₃)H—; —N(Si(alkyl)₃)—CH₂—C(CH₃)H—CH₂—;
—N(Si(alkyl)₃)—CH₂CH₂—C(CH₃)H—; —N(Si(alkyl)₃)—C(CH₃)H—CH₂—CH₂—.

Examples of reagents according to formula (7) include: 2,2-dimethyl-1-oxa-2-silacyclohexan-6-one, 2,2,4-trimethyl-1-oxa-2-silacyclohexan-6-one, 2,2,5-trimethyl-1-oxa-2-silacyclohexan-6-one. 2.2,4,5-tetramethyl-1-oxa-2-silacyclohexan-6-one, 2,2-diethyl-1-oxa-2-silacyclohexan-8-one, 2,2-diethoxy-1-oxa-2-silacyclohexan-6-one, 2,2-dimethyl-1,4-dioxa-2-silacyclohexan-6-one, 2,2.5-trimethyl-1,4-dioxa-2-silacyclohexan-6-one, 2,2,3,3-tetramethyl-1,4-dioxa-2-silacyclohexan-6-one, 2,2-dimethyl-1-oxa-4-thia-2-silacyclohexan-6-one, 2,2-diethyl-1-oxa-4-thia-2-silacyclohexan-6-one, 2,2-diphenyl-1-oxa-4-thia-2-silacyclonexan-6-one, 2-methyl-2-ethenyl-1-oxa-4-thia-2-silacyclohexan-6-one, 2,2,5-trimethyl-1-oxa-4-thia-2-silacyclohexan-6-one, 2,2-dimethyl-1-oxa-4-aza-2-silacyclohexan-6-one, 2,2,4-trimethyl-1-oxa-4-aza-2-silacyclohexan-6-one, 2,4-dimethyl-2-phenyl-1-oxa-4-aza-2-silacyclohexan-6-one, 2,2-dimethyl-4-trimethylsilyl-1-oxa-4-aza-2-silacyclohexan-8-one, 2,2-diethoxy-4-methyl-1-oxa-4-aza-2-silacyclohexan-6-one, 2,2,4,4-tetramethyl-1-oxa-2,4-disilacyclohexan-8-one, 3,4-dihydro-3,3-dimethyl-1H-2,3-benzoxasilin-1-one, 2,2-dimethyl-1-oxa-2-silacyclopentan-5-one, 2,2,3-trimethyl-1-oxa-2-silacyclopenten-5-one, 2,2-dimethyl-4-phenyl-1-oxa-2-silacyclopentan-5-one, 2,24(tert-butyl)-1-oxa-2-silacyclopentan-5-one, 2-methyl-2-(2-propen-1-yl)-1-oxa-2-silacyclopentan-5-one, 1,1-dimethyl-2,1-benzoxasilol-3(1H)-one, 2,2-dimethyl-1-oxa-2-silacycloheptan-7-one.

Reagents according to formula (7) are described, for example, in US2016/0075809A1, in particular in [0034]-[0042]. The use of such a reagent alone or by adding it to another functionalization reagent, for example a reagent according to formula (6) can lead to the creation of silacarboxylate groups, for example groups according to the general formula —Si(R¹)(R²)—C(R³)(R⁴)—A—COO.

Functionalization reagents according to formula (8):

Reagents according to formula (8) include oxa-silacycloalkanes. In formula (8) R¹, R², R³, R² and A are the same as described for formula (7). Examples of specific reagents according to formula (8) include: 2,2-dimethyl-1-oxa-2-silacyclohexane, 2,2-diethyl-1-oxa-2-silacyclohexane, 2.2-dipropyl-1-oxa-2-silacyclohexane, 2-methyl-2-phenyl-1-oxa-2-silacyclohexane, 2,2-diphenyl-1-oxa-2-silacyclohexane, 2,2,5,5-tetramethyl-1-oxa-2-silacyclohexane, 2,2,3-trimethyl-1-oxa-2-silacyclohexane, 2,2-di methyl-1-oxa-2-silacyclopentane, 2,2,4-trimethyl-1-oxa-2-silacyclopentane, 2,2-dimethyl-1,4-dioxa-2-silacyclohexane, 2,2,5,5-tetramethyl-1,4-dioxa-2,5-disilacyclohexane, 2,2,4-trimethyl-1-oxa-4-aza-2-benzo-2,2-dimethyl-1,4-dioxa-2-silacyclohexane, silacyclohexane, benzo-2,2,4-trimethyl-1-oxa-4-aza-2-silacyclohexane. Reagents according to formula (8) are described, for example in US2013/0281605A1. The use of reagents according to formula (8) may lead to carbinol groups corresponding to the formula —S(R¹)(R²)—C(R³)(R⁴)—A—OH.

Functionalization reagents according to formula (9):

The reagents according to formula (9) include bis(trialkylsilyl) peroxides. R¹, R², and R³ can be identical or different and are selected from linear or branched or cyclic alkyls which, optionally, can comprise heteroatoms selected from O, N, S, and Si and a combination thereof. Preferably, they are selected from C1-C10 linear alkyls and preferably they are all identical. Preferably at least one of R¹, R² and R³ is methyl and more preferably all are methyl.

Functionalization reagents according to formula (10):

The reagents according to formula (10) include cyclic ureas. In formula (10) R₃ represents a divalent, saturated or unsaturated, linear or branched, preferably aliphatic, hydrocarbon group having from 1 to 20 carbon atoms which, in addition to C and H, may contain one or more heteroatoms, preferably independently of one another selected from O, N, S or Si. Preferably R₃ corresponds to the general formula (11):

—[CHX¹]ₒ—[CHX²]ₚ—[O]_{z}—[CHX³]_{q}— (11)

wherein z is 1 or 0, o, p and q are independently selected from 0, 1 and 2 with the proviso that at least one of o, p and q is not 0. X¹, X² and X³ are independently selected from H and linear or branched alkyl, alkylaryl and aryl groups having from 1 to 12 carbon atoms and from aminoalkyl (N—R) groups wherein R is a linear or branched or cyclic alkyl or alkylaryl residue having from 1 to 12 carbon atoms, and X¹ and X² may represent a chemical bond between to form a carbon-carbon bond to provide an unsaturation in the carbon chain. o, p, q, X¹, X² and X³ are selected such that the total number of carbon atoms is not more than 20.

In one embodiment of the present disclosure R₃ is selected from substituted alkylenes, for example from substituted alkylenes corresponding to formula (11) wherein at least one of X¹, X² and X³ is not H.

In one embodiment of the present disclosure R₃ is selected from unsubstituted alkylenes, for example from unsubstituted alkylenes corresponding to formula (11) wherein all of X¹, X² and X³ are H. In a preferred embodiment R₃ corresponds to —[(CH)₂]ₙ—, wherein n is an integer from 1 to 5, preferably 1 to 3, more preferably 1 or 2.

In one embodiment of the present disclosure R₃ is selected from unsaturated substituted or unsubstituted alkylenes and, for example, corresponds to formula (IIa) wherein X¹ and X² together form a carbon-carbon bond. Specific examples of unsaturated alkylenes include but are not limited to —CH═CH— or —CH₂—CH═CH—.

In formula (10) R₁ and R₂ are identical or different and represent saturated or unsaturated hydrocarbon groups having from 1 to 20 carbon atoms and wherein the hydrocarbon group may contain, in addition to C and H atoms, one or more heteroatoms, preferably selected from the group consisting of O, N, S and Si. For example, R₁ and R₂ may be identical or different and are selected from -(C₁-C₂₀)-alkyl, -(C₃-C₂₀)-cycloalkyl, -(C₆-C₂₀)-aryl, -(C₆-C₂₀)-alkaryl or -(C₆-C₂₀)-aralkyl radicals which may contain one or more heteroatoms, preferably independently selected from O, N, S or Si. Preferably R₁, R₂ are selected independently from each other from methyl, ethyl, n-propyl, isopropyl, n-butyl, sec-butyl, tert-butyl, trialkyl silyl with alkyl groups of 1 to 4 carbon atoms per alkyl group, phenyl and phenyls independently substituted with one, two or three methyl-, ethyl-, propyl, and/or-butyl residues.

Preferred specific examples of agents according to formula (10) include but are not limited to: 1,3-dimethyl-2-imidazolidinone, 1,3-diethyl-2-imidazolidinone, 1-methyl-3-phenyl-2-imidazolidinone, 1,3-diphenyl-2-imidazolidinone, 1,3,4-trimethyl-2-imidazolidinone, 1,3-bis(trimethylsilyl)-2-imidazolidinone, 1,3-dihydro-1,3-dimethyl-2H-imidazol-2-one, tetrahydro-1,3-dimethyl-2(1H)-pyrimidinone, tetrahydro-1-methyl-3-phenyl-2(1H)-pyrimidinone, tetrahydro-1,3,5-trimethyl-2(1H)-pyrimidinone, tetrahydro-3,5-dimethyl-4H-1,3,5-oxadiazin-4-one, tetrahydro-1,3,5-trimethyl-1,3,5-triazin-2(1H)-one, hexahydro-1,3-dimethyl-2H-1,3-diazepin-2-one. A particularly preferred example is 1,3-dimethyl-2-imidazolidinone, also referred to as DMI, i.e. R₃ is —CH₂—CH₂— and/or R₁ and R₂ are both —CH₃.

Reagents according to formula (10) are described, for example, in U.S. Pat. No. 4,894,409, and international patent applications WO2021/009154 and WO2021/009156.

The functionalization reagents described above can react with reactive chain ends of the polymer and are therefore also referred to herein as “omega-functionalization reagents.” Instead of or in addition to adding the omega-functionalization reagents, “alpha-functionalization agents” may be added at the beginning of the polymerization, for example as functionalized initiators. This typically leads to alpha-functionalized polymers, i.e., polymers with polar groups at the beginning of the chain. Examples of alpha-functionalization reagents are described in EP 2847264 A1 and EP 2847242 A1.

In case the polymerization reaction is not terminated by the reaction with one or more omega-functionalization agents, the polymerization reaction may be terminated, for example by quenching. Quenching agents known in the art may be used. Typical quenching agents for terminating the polymerization include alcohols, for example octanol.

The polymers may be worked up and isolated as known in the art. Therefore, the method according to the present disclosure may further comprise at least one of the following steps: terminating the polymerization, adding at least one stabilizing agent, adding at least one extender oil, isolating the polymer, adding at least one filler, shaping the polymer. Extender oils used for diene rubbers such as TDAE (Treated Distillate Aromatic Extract)-, MES (Mild Extraction Solvates)-, RAE (Residual Aromatic Extract)-, TRAE (Treated Residual Aromatic

Extract)-, naphthenic and heavy naphthenic oils can be added to the reaction mixture prior or during work up for providing oil-extended rubbers. The solvent can be removed from the reaction mixture by conventional methods including distillation, stripping with steam or by applying a vacuum or reduced pressure, if necessary, at elevated temperatures. Typically, the solvent is recycled. The polymer crumbs can be further dried on mills or processed on mills, for example into sheets, or powders or compressed for example into bales or extruded into granules.

### Polymer Compounds

The polymers according to the present disclosure can be used to produce polymer compounds, in particular rubber compounds. Rubber compounds can be prepared by a process comprising mixing at least one polymer according to the present disclosure with at least one filler. The rubber compounds may be vulcanizable and further comprise one or more than one curing agent. The curing agent is capable of crosslinking (curing) the diene polymer and is also referred to herein as “crosslinker” or “vulcanization agent”. Suitable curing agents include, but are not limited to, sulfur, sulfur-based compounds, and organic or inorganic peroxides. Instead of a single curing agent a combination of one or more curing agents may be used, or a combination of one or more curing agent with one or more curing accelerator or curing catalysts may be used. Examples of sulfur-containing compounds acting as sulfur-donors include but are not limited to sulfur, sulfur halides, dithiodimorpholine (DTDM), tetramethylthiuramdisulphide (TMTD), tetraethylthiuramdisulphide (TETD), and dipentamethylenthiuramtetrasulphide (DPTT). Examples of curing accelerators include but are not limited to amine derivates, guanidine derivates, aldehydeamine condensation products, thiazoles, thiuram sulphides, dithiocarbamates and thiophosphates.

In another embodiment of the present disclosure the curing agent includes a peroxide. Examples of peroxides used as vulcanizing agents include but are not limited to di-tert.-butyl-peroxides, di-(tert.-butyl-peroxy-trimethyl-cyclohexane), di-(tert.-butyl-peroxy-isopropyl-)benzene, dichloro-benzoylperoxide, dicumylperoxides, tert.-butyl-cumyl-peroxide, dimethyl-di(tert.-butyl-peroxy)hexane and dimethyl-di(tert.-butyl-peroxy)hexine and butyl-di(tert.-butyl-peroxy)valerate. A vulcanizing accelerator of sulfene amide-type, guanidine-type, or thiuram-type can be used together with a vulcanizing agent as required.

If added, the vulcanizing agent is typically present in an amount of from 0.5 to 10 parts by weight, preferably of from 1 to 6 parts by weight per 100 parts by weight of rubber.

Conventional fillers can be used. Conventional fillers include silicas and carbon-based fillers, for example carbon blacks. The fillers can be used alone or in a mixture. In a particularly preferred form, the rubber compositions contain a mixture of silica fillers and carbon black. The weight ratio of silica fillers to carbon black may be from 0.01:1 to 50:1, preferably from 0.05:1 to 20:1.

Preferably, the filler includes silica-containing particles, preferably having a BET surface area (nitrogen absorption) of from 5 to 1,000, preferably from 20 to 400 m²/g. Such fillers may be obtained, for example, by precipitation from solutions of silicates or by flame hydrolysis of silicon halides. Silica-containing filler particles may have particle sizes of 10 to 400 nm. The silica-containing filler may also contain oxides of Al, Mg, Ca, Ba, Zn, Zr or Ti. Other examples of silicon-oxide based fillers include aluminum silicates, alkaline earth metal silicates such as magnesium silicates or calcium silicates, preferably with BET surface areas of 20 to 400 m²/g and primary particle diameters of 10 to 400 nm, natural silicates, such as kaolin and other naturally occurring silicates including clay (layered silicas). Further examples of fillers include glass particle-based fillers like glass beads, microspheres, glass fibers and glass fiber products (mats, strands).

Polar fillers, like silica-containing fillers, may be modified to make them more hydrophobic. Suitable modification agents include silanes or silane-based compounds. Typical examples of such modifying agents include, but are not limited to compounds corresponding to the general formula (11):

(R¹R²R³O)₃Si—R⁴—X (11)

wherein each R¹, R², R³ is, independently from each other, an alkyl group, preferably R¹, R², R³ are all methyl or all ethyl, R⁴ is an aliphatic or aromatic linking group with 1 to 20 carbon atoms and X is sulfur-containing functional group and is selected from —SH, —SCN, —C(═O)S or a polysulfide group.

Instead of or in addition to silicas that have been modified as described above such modification may also take place in situ, for example during compounding or during the process of making tires or components thereof, for example by adding modifiers, preferably silanes or silane-based modifiers, for example including those according to formula (11), when making the rubber compounds.

Filler based on metal oxides other than silicon oxides include but are not limited to zinc oxides, calcium oxides, magnesium oxides, aluminum oxides and combinations thereof. Other fillers include metal carbonates, such as magnesium carbonates, calcium carbonates, zinc carbonates and combinations thereof, metal hydroxides, e.g. aluminum hydroxide, magnesium hydroxide and combinations thereof, salts of alpha-beta-unsaturated fatty acids and acrylic or methacrylic acids having from 3 to 8 carbon atoms including zinc acrylates, zinc diacrylates, zinc methacrylates, zinc dimethacrylates and mixtures thereof.

In another embodiment of the present disclosure the rubber compound contains one or more fillers based on carbon, for example one or more carbon black. The carbon blacks may be produced, for example, by the lamp-black process, the furnace-black process or the gas-black process. Preferably, the carbon back has a BET surface area (nitrogen absorption) of 20 to 200 m²/g. Suitable examples include but are not limited to SAF, ISAF, HAF, FEF and GPF blacks.

Other examples of suitable filler include carbon-silica dual-phase filler, lignin or lignin-based materials, starch or starch-based materials and combinations thereof.

In a preferred embodiment, the filler comprises one or more silicon oxide, carbon black or a combination thereof.

Typical amounts of filler include from 5 to 200 parts per hundred parts of rubber, for example, from 10 to 150 parts by weight, or from 10 to 95 parts by weight for 100 parts by weight of rubber.

The rubber compounds may further contain one or more additional rubbers other than the diene rubbers according to the present disclosure and one or more than one rubber additive. Additional rubbers include, for example, natural rubber and synthetic rubber. If present, they may be used in amounts in the range from 0.5 to 95% by weight, preferably in the range from 10 to 80% by weight, based on the total amount of rubber in the composition. Examples of suitable synthetic rubbers include BR (polybutadiene), acrylic acid alkyl ester copolymers, IR (polyisoprene), E-SBR (styrene-butadiene copolymers produced by emulsion polymerization), S-SBR (styrene-butadiene copolymers produced by solution polymerization), IIR (isobutylene-isoprene copolymers), NBR (butadiene-acrylonitrile copolymers), HNBR (partially or completely hydrogenated NBR rubber), EPDM (ethylene-propylene-diene terpolymers) and mixtures thereof. Natural rubber, E-SBR and S-SBR with a glass temperature above −60° C., polybutadiene rubber with a high cis content (>90%) produced with catalysts based on Ni, Co, Ti or Nd, polybutadiene rubber with a vinyl content of up to 80% and mixtures thereof are of particular interest for the manufacture of automotive tires.

The rubber compounds may also comprise one or more rubber additive. Rubber additives are ingredients that may improve the processing properties of the rubber compositions, serve to crosslink the rubber compositions, improve the physical properties of the vulcanizates produced from the rubber, improve the interaction between the rubber and the filler or serve to bond the rubber to the filler. Rubber auxiliaries include, but are not limited to reaction accelerators, antioxidants, heat stabilizers, light stabilizers, ozone stabilizers, processing aids, plasticizers, tackifiers, blowing agents, dyes, pigments, waxes, extenders, organic acids, silanes, retarders, metal oxides, extender oils such as DAE (Distillate Aromatic Extract)-, TDAE (Treated Distillate Aromatic Extract)-, MES (Mild Extraction

Solvates)-, RAE (Residual Aromatic Extract)-, TRAE (Treated Residual Aromatic Extract)-, naphthenic and heavy naphthenic oils as well as activators.

The total amount of rubber additives may range from 1 to 300 parts by weight, preferably from 5 to 150 parts by weight based on 100 parts by weight of total rubber in the composition.

The rubber compositions can be prepared with conventional processing equipment for making and processing of (vulcanizable) rubber compounds and include rollers, kneaders, internal mixers or mixing extruders. The rubber compositions can be produced in a single-stage or a multi-stage process, with 2 to 3 mixing stages being preferred. Cross-linking agents, for example sulfur, and accelerators may be added in a separate mixing stage, for example on a roller, with temperatures in the range of 30° C. to 90° C. being preferred. Cross-linking agent, for example sulfur, and accelerator are preferably added in the final mixing stage.

### Applications

The rubber compositions according to the present disclosure can be used for producing rubber vulcanizates., in particular for producing tires, in particular tire treads. Rubber vulcanizates can be obtained by providing a vulcanizable composition comprising a polydiene polymer according to the present disclosure and subjecting the composition to at least one curing reaction. The composition can be subjected to shaping prior, during or after the curing reaction. Shaping may be carried out by process steps including molding, extruding and a combination thereof. The (vulcanizable) compositions provided herein are also suitable for the manufacture of other articles, for example for the manufacture of cable sheaths, hoses, drive belts, conveyor belts, roll linings, shoe soles, sealing rings and damping elements.

### EXAMPLES

The following examples are provided to further illustrate the present disclosure without, however, intending to limit the disclosure to the embodiments set forth in these examples.

### Methods

The number-average molecular weight Mn, the weight average molecular weight, the dispersity Ð=Mw/Mn (also referred to herein as molecular weight distribution or MWD) and the degree of coupling of the polymers were determined using gel permeation chromatography (GPC) at 35° C. (THF as solvent and polystyrene calibration).

The Mooney viscosity was measured according to DIN ISO 289-1 (2018) at the measuring conditions ML(1+4) at 100° C. Mooney Stress Relaxation (MSR) was determined from the same measurement according to ASTM D 1646-00.

Dynamic properties of vulcanized compounds were determined according to DIN53513-1990 on Eplexor 500 N from Gabo-Testanlagen GmbH, Ahlden, Germany at 10 Hz in the temperature range from −100° C. to +100° C. at a heating rate of 1 K/min (Sample: strips with l*w*t=60 mm*10 mm*2 mm; free length between sample holder 30 mm). The following properties can be determined this way: tan δ (60° C.), i.e. the loss factor (E″/E′) at 60° C.; and tan δ (0° C.), i.e. the loss factor (E″/E′) at 0° C. tan δ (60° C.) is a measure of hysteresis loss from the tire under operating conditions. As tan δ (60° C.) decreases, the rolling resistance of the tire decreases. tan δ (0° C.) is a measure for the wet grip of the material. As tan δ (0° C.) increases the wet grip increases.

Elastic properties were determined according to DIN53513-1990. An elastomer test system (MTS Systems GmbH, 831 Elastomer Test System) was used. The measurements were carried out in double shear mode with no static pre-strain in shear direction and oscillation around 0 on cylindrical samples (2 samples each 20×6 mm, pre-compressed to 5 mm thickness) and a measurement frequency of 10 Hz in the strain range from 0.1 to 40%. The method was used to obtain the following properties: G′ (0.5%): dynamic modulus at 0.5% amplitude sweep, G′ (15%): dynamic modulus at 15% amplitude sweep, G′ (0.5%)−G′ (15%): difference of dynamic modulus at 0.5% relative to 15% amplitude sweep, tan δ (max): maximum loss factor (G″/G′) of entire measuring range at 60° C.

The difference of G′ (0.5%)−G′ (15%) is an indication of the Payne effect of the mixture. The lower the value the better the distribution of the filler in the mixture, the better the rubber-filler interaction. Tan δ (max) is another measure of the hysteresis loss from the tire under operating conditions. As tan δ (max) decreases, the rolling resistance of the tire decreases.

The rebound elasticity was determined at 60° C. according to DIN 53512.

### Synthesis Examples

Triethyl sylsilyloxy-4-vinyl-2-methoxybenzene (TES-4VG) and tert.-butyldimethylsilyloxy-4-vinyl-2-methoxybenzene (TBDMS-4VG) were prepared as described in H. Takeshima et al, Macromolecules, 2017, 50, 4206-4216.

### Example 1 (Comparative): Production of a Non-Functionalized Reference Polymer

A moisture-free and nitrogen-flushed 20 L reactor was charged with 8500 g hexane, 1185 g butadiene, 315 g styrene and 5.43 mmol DTHFP (2,2-bis(2-tetrahydrofuryl)propane). The reaction mixture was heated to 33° C. and adiabatic polymerization was initiated by addition of 9.8 mmol butyl lithium and reacted for 60 min. The maximum temperature was 60.4° C. The polymerization was terminated by addition of 10 mmol 1-octanol and stabilized with 4.5 g IRGANOX 1520. The polymer was isolated by steam-stripping and drying at 60° C. under reduced pressure.

### Example 2 (Comparative): Omega Silane-Functionalized Reference Polymer

A moisture-free and nitrogen-flushed 20 L reactor was charged with 8500 g hexane, 1185 g butadiene, 315 g styrene and 5.43 mmol DTHFP. The reaction mixture was heated to 33° C. and adiabatic polymerization was initiated by addition of 9.8 mmol BuLi (T Max 60.8° C.) and reacted for 60 min. In a second step the polymer was treated to produce silane-containing carboxylate end groups as described in US2016/0075809A1. The reaction was terminated by addition of 10 mmol 1-octanol and stabilized with 4.5 g IRGANOX 1520. The polymer was isolated by steam-stripping and drying at 60° C. under reduced pressure.

### Example 3 (Comparative): Polymer Backbone-Modified with Triethyl sylsilyloxy-4-vinyl-2-methoxybenzene

A moisture-free and nitrogen-flushed 20 L reactor was charged with 8500 g hexane, 1185 g butadiene, 315 g styrene, 5.43 mmol DTHFP, and 22.7 mmol triethyl sylsilyloxy-4-vinyl-2- methoxybenzene (TES-4VG). The reaction mixture was heated to 33° C. and adiabatic polymerization was initiated by addition of 9.8 mmol butyl lithium (T Max 46° C.). The reaction is terminated by addition of 1-octanol and stabilized with 4.5 g IRGANOX 1520. The polymer was isolated by precipitation in ethanol and was dried at 60° C. under reduced pressure.

### Example 4: Backbone-Functionalized Polymer

A moisture-free and nitrogen-flushed 20 L reactor was charged with 8500 g hexane, 1185 g butadiene, 315 g styrene, 5.43 mmol DTHFP, and 37.8 mmol TBDMS-4VG. The reaction mixture was heated to 33° C. and adiabatic polymerization was initiated by addition of 9.8 mmol butyl lithium (T Max 60.3° C.). After polymerization the reaction was terminated by addition of 10 mmol 1-octanol and stabilized with 4.5 g IRGANOX 1520. The polymer was isolated by steam-stripping of 5 kg polymer cement and drying at 60° C. under reduced pressure.

### Example 5: Conversion of a Backbone-Functionalized Polymer by Treatment with a Lewis Acid

5 kg of the polymer cement prepared in Example 4 were reacted with 24 mmol tert.-butyl ammonium fluoride at ambient temperature for 24 h. The polymer was isolated by steam-stripping and subsequent drying at 60° C. under reduced pressure.

### Example 6: Backbone Functionalized Polymer Additionally Functionalized to Have Omega Silane Groups

A moisture-free and nitrogen-flushed 20 L reactor was charged with 8500 g hexane, 1185 g butadiene, 315 g styrene, 5.43 mmol DTHFP, and 22.69 mmol TBDMS-4VG.

The reaction mixture was heated to 33° C. and adiabatic polymerization was initiated by addition of 9.8 mmol butyl lithium (T Max 59.23° C.) and reacted for 60 min In a second step the polymer was treated to produce silane-containing carboxylate end groups as described in example 2.

### Example 7: Omega-Functionalized Polymer

The polymer was prepared by the same procedure as in Example 1. Additionally, after polymerization 5.7 mmol tert.-butyldimethylsilyloxy-4-vinyl-2-methoxybenzene were added to the living polymer solution and reacted for further 30 min at 60° C. The reaction was terminated by addition of 10 mmol 1-octanol and stabilized with 4.5 g IRGANOX 1520. The polymer was isolated by steam-stripping of 5 kg polymer cement and drying at 60° C. under reduced pressure.

### Example 8: Alpha-Functionalized Polymer and its Conversion by Treatment with a Lewis Acid

A moisture-free and nitrogen-flushed reactor was charged with 8500 g hexane, 5.43 mmol DTHFP and 25.1 mmol tert.-butyldimethylsilyloxy-4-vinyl-2-methoxybenzene. 12.57 mmol butyl lithium were added and the reaction mixture was kept at 33° C. for 15 min. Subsequently, 1185 g butadiene and 315 g styrene were added simultaneously to the reaction mixture which was then polymerized for 60 min at 60° C. The reaction was terminated by addition of 13 mmol 1-octanol and stabilized with 4.5 g IRGANOX 1520. The polymer cement was reacted with 50 mmol tert.-butylammoniumfluoride at ambient temperature for 24 h. The polymer was isolated by steam-stripping and drying at 60° C. under reduced pressure.

### Example 9: Alpha-Functionalized Polymer That is Additionally Functionalized with Omega Silane Groups and its Conversion by Treatment with a Leis Acid

A moisture-free and nitrogen-flushed reactor was charged with 8500 g hexane, 5.43 mmol DTHFP and 25.1 mmol tert.-butyldimethylsilyloxy-4-vinyl-2-methoxybenzene. 12.57 mmol butyl lithium were added and the reaction mixture was kept at 33° C. for 15 min. Thereafter 1185 g butadiene and 315 g styrene were added simultaneously, and the reaction mixture was polymerized for 60 min at 60° C. In a second step In a second step the polymer was treated to produce silane-containing carboxylate end groups as described in example 2. The reaction was terminated by addition of 13 mmol 1-octanol and stabilized with 4.5 g IRGANOX 1520. The polymer cement was reacted with 50 mmol tert.-butylammoniumfluoride at ambient temperature for 24 h. The polymer was isolated by steam-stripping and drying at 60° C. under reduced pressure.

TABLE 1
Characterization of the polymers from examples 1 to 3

| | Examples (comparative) | | |
|---|---|---|---|
| | 1 | 2 | 3 |
| Polymer Yield/% | 99 | 100 | 54 |
| Mₙ/kg mol⁻¹ | 271 | 255 | 163 |
| Ð | 1.13 | 1.24 | 2.54 |
| Styrene/% | 20.6 | 20.3 | 24 |
| 1,2-Vinyl/% | 49.5 | 49 | 53.8 |
| Tg/° C. | −22.6 | −24.6 | n.d. |
| ML1 + 4@100° C./ | 47 | 90 | 57 |
| MU | | | |
| MSR | 2.272 | 1.404 | 1.076 |

Characterization of the polymers from examples 4 to 9

| | Examples | | | | | |
|---|---|---|---|---|---|---|
| | 4 | 5 | 6 | 7 | 8 | 9 |
| Polymer Yield/% | 98 | 98 | 100 | 100 | 99 | 100 |
| Mn/kg mol⁻¹ | 255 | 259 | 253 | 246 | 258 | 265 |
| Ð | 1.27 | 1.29 | 1.31 | 1.20 | 1.20 | 1.18 |
| Styrene/% | 20.7 | 20.7 | 20.9 | 20.4 | 20.7 | 20.9 |
| 1,2-Vinyl/% | 51.4 | 51.4 | 51.7 | 49.9 | 51.2 | 51.1 |
| Tg/° C. | −22.7 | −21.1 | −20.3 | −23.2 | −21.0 | −21.0 |
| ML1 + 4@100° C./ | 56 | 54 | 71 | 45 | 41 | 43 |
| MU | | | | | | |
| MSR | 2.589 | 1.428 | 1.358 | 3.389 | 1.903 | 1.687 |

### Compound Studies (Examples 10-17)

Rubber compositions (examples 10-17) comprising the polymers produced in examples 1, 2, and 4 to 9 were prepared in a 1.5 L kneader with the ingredients shown in table 3 using the mixing protocol shown in table 2. The resulting compositions were vulcanized at 160° C. for 30 min. The properties of the vulcanizates are summarized in table 3.

TABLE 2
Mixing protocol.

| | | | |
|---|---|---|---|
| Step 1: Mixing in | 0 | s | Addition of polymers |
| a 1.5 L kneader | 30 | s | Addition of 2/3 silica, 2/3 silane, |
| | | | stabilizers, stearic acid |
| | 90 | s | Addition of 1/3 silica, 1/3 silane, |
| | | | oil, carbon black |
| | 210 | s | Heat up to 150° C. and hold for 3 min |

| | |
|---|---|
| Step 2: Mill | 3 × r/l cross-cutting and folding, 3 × end roll (4 mm) |
| Step 3: Storage | 24 h |
| Step 4: Mixing in | Heat up to 150° C. and hold at temperature for 3 min |
| a 1.5 L kneader | |
| Step 5: Mill | 3 × r/l cross-cutting and folding (4 mm) |
| | Sulfur, accelerators, DPG, ZnO |
| | 3 × r/l cross-cutting and folding, 5 × end roll (4 mm) |

TABLE 3
Compound recipes and test results (examples 10-13)

| | Example 10 | Example 11 | | |
|---|---|---|---|---|
| | (comparative) | (comparative) | Example 12 | Example 13 |
| Polymer from | 70 | | | |
| Example 1 | | | | |
| Polymer from | | 70 | | |
| Example 2 | | | | |
| Polymer from | | | 70 | |
| Example 4 | | | | |
| Polymer from | | | | 70 |
| Example 5 | | | | |
| NdBR CB24 | 30 | 30 | 30 | 30 |
| ULTRASIL 7000 | 90 | 90 | 90 | 90 |
| GR (silica) | | | | |
| N375 (carbon | 5 | 5 | 5 | 5 |
| black) | | | | |
| VIVATEC 500 | 31 | 31 | 31 | 31 |
| AFLUX 37 | 3 | 3 | 3 | 3 |
| VULKANOX | 2 | 2 | 2 | 2 |
| 4020/LG | | | | |
| VULKANOX | 2 | 2 | 2 | 2 |
| HS/LG | | | | |
| ANTILUX 654 | 2 | 2 | 2 | 2 |
| SI 69 | 7.2 | 7.2 | 7.2 | 7.2 |
| SULPHUR 90/95 | 1.7 | 1.7 | 1.7 | 1.7 |
| RHENOGRAN | 3.75 | 3.75 | 3.75 | 3.75 |
| ZnO-80 | | | | |
| PALMERA A 9818 | 1 | 1 | 1 | 1 |
| RHENOGRAN | 2.5 | 2.5 | 2.5 | 2.5 |
| DPG-80 | | | | |
| RHENOGRAN | 2 | 2 | 2 | 2 |
| TBBS-80 | | | | |
| Comp. ML1 + 4 | 55.7 | 81.9 | 57.9 | 63.9 |
| (MU) | | | | |
| Rebound at 60° C. | 60.5 | 63.5 | 62.5 | 63 |
| (%) | | | | |
| ΔG′ (0.5%; 15%) | 1.38 | 0.79 | 0.56 | 1.13 |
| (MPa) | | | | |
| Heat Build-up (K) | 21.8 | 16.8 | 15.3 | 16.1 |
| tan δ at 0° C. | 0.291 | 0.294 | 0.308 | 0.314 |
| (Eplexor, 10 Hz) | | | | |
| tan δ at 60° C. | 0.110 | 0.072 | 0.074 | 0.099 |
| (Eplexor, 10 Hz) | | | | |

Compound recipes and test results (examples 14 to 17)

| | Example 14 | Example 15 | Example 16 | Example 17 |
|---|---|---|---|---|
| Polymer from | 70 | | | |
| Example 6 | | | | |
| Polymer from | | 70 | | |
| Example 7 | | | | |
| Polymer from | | | 70 | |
| Example 8 | | | | |
| Polymer from | | | | 70 |
| Example 9 | | | | |
| NdBR CB24 | 30 | 30 | 30 | 30 |
| ULTRASIL 7000 | 90 | 90 | 90 | 90 |
| GR (silica) | | | | |
| N375 (carbon | 5 | 5 | 5 | 5 |
| black) | | | | |
| VIVATEC 500 | 31 | 31 | 31 | 31 |
| AFLUX 37 | 3 | 3 | 3 | 3 |
| VULKANOX | 2 | 2 | 2 | 2 |
| 4020/LG | | | | |
| VULKANOX | 2 | 2 | 2 | 2 |
| HS/LG | | | | |
| ANTILUX 654 | 2 | 2 | 2 | 2 |
| SI 69 | 7.2 | 7.2 | 7.2 | 7.2 |
| SULPHUR 90/95 | 1.7 | 1.7 | 1.7 | 1.7 |
| RHENOGRAN | 3.75 | 3.75 | 3.75 | 3.75 |
| ZnO-80 | | | | |
| PALMERA A 9818 | 1 | 1 | 1 | 1 |
| RHENOGRAN | 2.5 | 2.5 | 2.5 | 2.5 |
| DPG-80 | | | | |
| RHENOGRAN | 2 | 2 | 2 | 2 |
| TBBS-80 | | | | |
| Comp. ML1 + 4 | 74.5 | 55.2 | 63.2 | 62.5 |
| (MU) | | | | |
| Rebound at 60° C. | 63.5 | 61.5 | 61.5 | 61.5 |
| (%) | | | | |
| ΔG′ (0.5%; 15%) | 0.53 | 0.83 | 1.04 | 0.99 |
| (MPa) | | | | |
| Heat Build-up (K) | 15 | 16.3 | 14.8 | 15.5 |
| tan δ at 0° C. | 0.319 | 0.291 | 0.305 | 0.325 |
| (Eplexor, 10 Hz) | | | | |
| tan δ at 60° C. | 0.067 | 0.070 | 0.075 | 0.076 |
| (Eplexor, 10 Hz) | | | | |

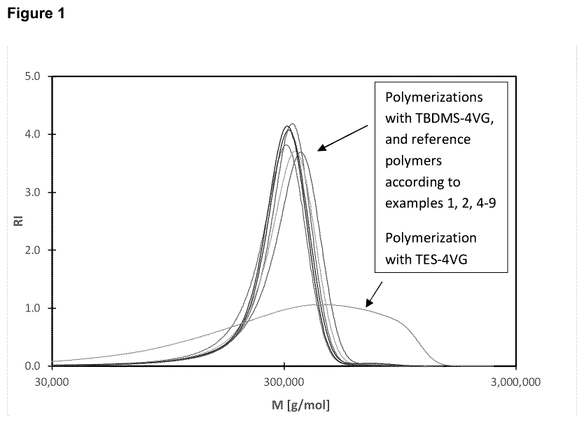

A comparison of example 3 with the other examples shows that use of TES-4VG leads to less defined polymers as shown by the broad GPC trace of example 3 in FIG. 1. The broad GPC trace indicates the presence of various ill-defined high molecular weight fractions—contrary to the GPC trace of the other polymers. This also demonstrates that the monomers according to the present disclosure with their branched and thus bulkier substituents can be polymerized also at elevated temperatures, for example temperatures between 50° to 70° C. or even higher temperatures, and still produce well-defined polymers as indicated by GPC traces having a narrow peak and thus a narrow PDI range as indicated in figure compare to monomers with linear substituents as TES-4VG. A polymerization at elevated temperatures allows for faster and thus more economic production processes.

Example 2 is a polymer that was end group-modified to contain polar silane end groups. Such polymers are known to improve properties in tires but are also known to have higher Mooney viscosities than their non-functionalized counterparts (Example 1) and are more difficult to process. A comparison of Example 2 with the polymers according to the present disclosure shows that modification with a functionalized comonomer according to the present disclosure provides functionalized polymers with reduced Mooney viscosities. The functionalising comonomer can also be used to reduce the Mooney viscosity of the silane-functionalized polymer of comparative Example 2.

The results of the compound studies presented in table 3 show that this effect was maintained in rubber compounds. The compound Mooney of the polymers modified according to the invention was similar of that of the compound obtained with the non-functionalized reference polymer, while the other compound properties did not change significantly. The same applies if the functionalized comonomers are used in combination with functionalizing agents. The advantageous properties introduced by the functionalizing agent were maintained but the Mooney viscosity was reduced, which is an indication for improved compound processing properties.

1. A method of making a polydiene polymer having at least 51% by weight based on the weight of the polymer of units derived from one or more conjugated diene, wherein the method comprises polymerizing at least one aliphatic conjugated diene monomer having from 4 to 25 carbon atoms and, optionally, one or more comonomers, wherein the method further comprises using at least one functionalizing comonomer according to formula (1) 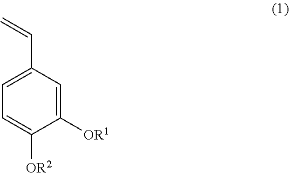
wherein the functionalising comonomer is either used at the beginning of the polymerizing to produce an alpha-functionalized polymer or at the end of the polymerizing to produce an omega-functionalized polymer or during the polymerizing to produce a backbone-modified polymer, or a combination thereof, and wherein in formula (1),
R¹ and R² are independently selected from alkyl residues having from 1 to 12 carbon atoms, which, optionally, may contain one or more halogen atoms or catenary ether oxygen atoms, and trialkyl silane residues of formula (2)
(R³)(R⁴)(R⁵)Si— (2)
wherein R³, R⁴ and R⁵ are independently selected from alkyl residues having from 3 to 32 carbon atoms which, optionally, may contain one or more halogen atoms or catenary ether oxygen atoms, and wherein at least one of R³, R⁴ and R⁵ is branched, and wherein at least one of R¹ and R² is a trialkyl silane residue of formula (2).

2. The method of claim 1, comprising reacting the functionalizing comonomer with itself to produce a second functional comonomer comprising repeating units derived from the functionalising comonomer according to formula (1) and subjecting this second comonomer to the polymerizing with the at least one aliphatic conjugated diene monomer and, optionally, the one or more comonomers.

3. The method of claim 1, wherein at least one of R³, R⁴ and R⁵ corresponds to the general formula (3):
(R′)(R″)(R″′)C—(CH₂)ₙ— (3)
wherein n represents 0, 1, or 2, and R′ R″ and R″′ are selected independently from each other from H, or an alkyl of 1 to 10 carbon atoms which, optionally, may contain one or more halogen atoms or catenary ether oxygen atoms, with the proviso that not more than one of R′, R″ and R″′ is H.

4. The method of claim 1, wherein at least one of R³, R⁴ and R⁵ corresponds to the general formula (3):
(R′)(R″)(R″′)C—(CH₂)ₙ— (3)
wherein n represents 0 and R′ R″ and R″′ are independently selected from an alkyl of 1 to 5 carbon atoms.

5. The method of claim 1, wherein either R¹ or R² is a linear or branched alkyl group with 1 to 6 carbon atoms.

6. The method of claim 1, wherein the conjugated diene monomer is selected from 1,3-butadiene, isoprene, 1,3-pentadiene, 2,3-dimethylbutadiene, 2-phenyl-1,3-butadiene, 1,3-hexadiene, and combinations thereof.

7. The method of claim 1, wherein the polymerizing further comprises copolymerizing one or more comonomers selected from copolymerizable vinyl aromatic comonomers.

8. The method claim 1, wherein the polymerizing comprises anionic polymerization.

9. The method of claim 1, wherein the method further comprises exchanging at least one of the residues R¹ and R² with hydrogen or a cation through treatment with at least one acidic agent wherein the acidic agent includes a Lewis acid and a Bronstedt acid.

10. The method of claim 1, further comprising reacting the polymer with at least one functionalisation agent to produce a polar functional end group that has in addition to C and H atoms at least one heteroatom selected from Si, S, N, O, and combinations thereof.

11. The method of claim 1, wherein the method further comprises at least one of the following steps: terminating the polymerizing, adding at least one stabilizing agent, adding at least one extender oil, isolating the polymer, adding at least one filler, or shaping the polymer.

12. A composition comprising a polymer obtained by the method according to claim 1.

13. The composition of claim 12, wherein the composition comprises at least one curing agent capable of curing the polymer.

14. An article comprising a cured composition obtained by subjecting the composition of claim 12 to a curing reaction.

15. A method of making a cured article comprising subjecting the composition of claim 12 to a curing reaction.

16. The method of claim 10, wherein the functionalisation agent is selected from the group consisting of linear or branched siloxanes, linear or branched silanes, and the reagents according to formulae (6) to (10) 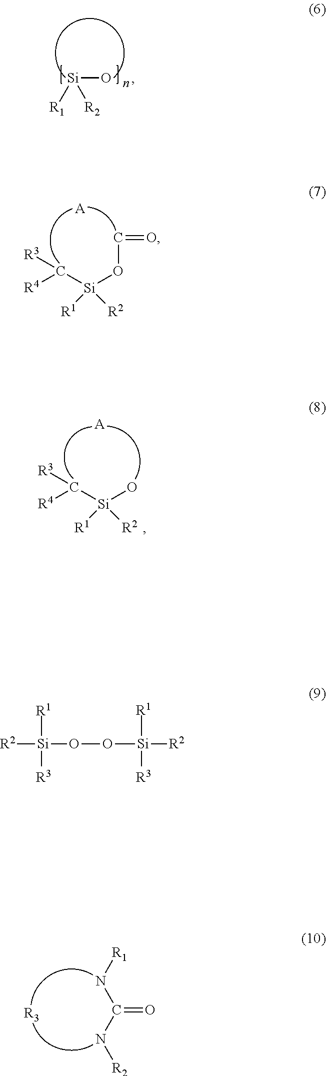
and combinations thereof.
